(19) United States
(12) Patent Application Publication
(10) Pub. No.: US 2009/0177392 A1
(43) Pub. Date: Jul. 9, 2009

(54) ON-VEHICLE ELECTRONIC SYSTEM, DISPLAY METHOD AND DISPLAY PROGRAM

(76) Inventor: Hayato Komaba, Iwaki-city (JP)

Correspondence Address: ALPINE/BHGL, P.O. Box 10395, Chicago, IL, 60610, US

(21) Appl. No.: 12/337,522

(22) Filed: Dec. 17, 2008

(30) Foreign Application Priority Data
Jan. 8, 2008 (JP) 2008-000926

(51) Int. Cl. G01C 21/34

(52) U.S. Cl. 701/211

(57) ABSTRACT

An on-vehicle electronic system and method provides a more simple operation to confirm and search audio data displayed on a navigation image. The on-vehicle electronic system may include: a navigation unit configured to perform a road guidance function; an audio reproduction unit configured to reproduce audio data; a display; and a display control unit. The display control unit may be configured to display a navigation image for a guidance function on the display when the road guidance function is executed, as well as an audio image related to the audio data currently being reproduced or to be reproduced by the audio reproduction unit on the navigation image for a predetermined period of time when an audio reproduction function is executed while the road guidance function is being executed by the navigation unit.

### BACKGROUND OF THE INVENTION

1. Related Applications

The present application claims priority to Japanese Patent Application Number 2008-000926, filed Jan. 8, 2008, the entirety of which is hereby incorporated by reference.

2. Field of the Invention

The present invention relates to an on-vehicle electronic system equipped with a navigation function and an audio function, and in particular to a method of displaying audio information on a navigation screen.

3. Description of the Related Art

On-vehicle electronic systems generally include a navigation system that searches a route to a destination and displays a road map surrounding a vehicle position, an audio system that reproduces audio data, and a visual system that reproduces video data and the like. Along with a general trend toward using reproduced data as multimedia, there is a growing demand that these on-vehicle electronic systems function as an integrated system, instead of functioning as individual components. In this specification, a system in which the navigation system, the audio system and the visual system are integrated is referred to as an AVNCR) (Audio Visual Navigation) system.

The AVN system integrates individual, independent functions, and displays various display information provided from the individual functions on a single display. As an example, when a navigation function is carried out, road map information and the like are presented on the display, and when an audio function is carried out, information for the reproduced audio data is presented on the display. Further, various user interface information is presented on the display.

Japanese Patent Laid-Open Publication No. 2003-202946 discloses a technique in which the transparency of the letters for the displayed content information is adjusted (e.g. the track number for music data, playback time, etc.) and the letters automatically disappear after being displayed for a given time. More specifically, at the time the displayed content information is switched, the information is displayed for a predetermined time by setting the transparency of the letters for the displayed content information to 0 %, and after the predetermined time elapses, the letters disappear from the screen by setting the transparency to 100%.

### SUMMARY OF THE INVENTION

In conventional AVN systems, in order to display audio information while carrying out a navigation function, the entire display screen is switched from a navigation screen to an audio screen, or alternatively, the display screen is divided into two parts with the navigation screen being displayed on one part, and the audio screen displayed on the other. In such a display mode, problems arise in that a part of the navigation screen is masked/covered up by the audio screen. Further, because the road map of the navigation screen is displayed at a reduced scale to accommodate for the reduced display area, the visibility of the map is deteriorated. This deterioration of the visibility of the map makes the map difficult to view and causes the display function of the navigation screen to be partially lost.

Further, if a user wants to change the music currently being reproduced, the user must switch the display from the navigation function to the audio function. Only after the display has switched to the audio function can the user search for desired music using a music search screen. Accordingly, the attribute data for the music currently being reproduced, as well as information regarding the media devices, are not reflected on the music search screen, thereby making the search operation more complex.

The present invention has been made in consideration of the above described problems of conventional systems, and an object thereof is to provide an on-vehicle electronic system, a display method, and a display program capable of easily confirming audio information from a navigation screen and to provide a simpler means of searching audio data.

According to one aspect of the present invention, the on-vehicle electronic system comprises: a navigation unit configured to perform a road guidance function; an audio reproduction unit configured to reproduce audio data; a display; and a display control unit configured to display a navigation image for a guidance function on the display when the road guidance function is executed. The display control unit also displays an audio image related to the audio data currently being reproduced or to be reproduced by the audio reproduction unit on the navigation image for a predetermined period of time when all audio reproduction function is executed while the road guidance function is being executed.

Preferably, the display control unit displays the audio image at predetermined time intervals, or displays the audio image in response to blank sections of the audio data. Preferably, the display control unit displays the audio image in a senutransparent state. The display control unit may include an attribute data acquisition unit that acquires attribute data from the audio data currently being reproduced or to be reproduced, and a creation unit that creates the audio image based on the attribute data acquired. The attribute data preferably includes at least one of the genre, artist, album and title associated with the audio data.

Preferably, the display control unit includes a display position determination unit that determines a position on the display that does not overlap with intersections or a guidance route on the navigation image, and the audio image is displayed at the position determined by the display position determination unit. Preferably, the display controlling unit includes a priority comparison unit that compares a predetermined priority for displaying the audio image to a predetermined priority for displaying the navigation image. When the priority for displaying the audio image is determined to be higher than the priority for the navigation image by the priority comparison unit, the display control unit displays the audio image. Preferably, when the priority for displaying the audio image is determined to be lower than the priority for displaying an intersection guidance image by the priority comparison unit, the display control unit does not display the audio image, and when the priority for displaying the audio image is determined to be lower than the priority for displaying an input screen of a navigation function, the display control unit does not display the audio image.

Preferably, the display control unit further includes a detection unit for detecting whether the audio image currently being displayed has been selected, and the display control unit displays a search screen for the audio data on the display in response to the detection by the detection unit. The audio image may include at least a first display area for displaying first attribute data and a second display area for displaying second attribute data. The detection unit may detect whether either of the first and the second display areas is selected, and the display control unit may display a search screen associated with the selected first or the second attribute data in response to the selection of the first or the second display area.

Preferably, the display control unit can change a display color of the audio image in conformity with a background color of the navigation image. The on-vehicle electronic system may further comprise a receiving unit that receives at least one of television and radio broadcasts, and the audio unit may reproduce the audio data of the received television or radio broadcast. The display control unit may display the audio image related to the audio data of the radio or television broadcast currently being received or to be received by the receiving unit on the navigation image. The display control unit may include an attribute data acquisition unit that acquires attribute data from an electronic program guide received by the receiving unit, and a creation unit that creates the audio image based on the attribute data.

According to the present invention, the method or program for displaying an audio image related to audio data on a navigation image in an on-vehicle electronic system comprises the steps of displaying the navigation image on a display; reproducing the audio data; and displaying the audio image related to the audio data currently being reproduced or to be reproduced for a predetermined period of time on the navigation image. Preferably, the audio image is repeatedly displayed at predetermined time intervals, or it is displayed each time the reproduced audio data is switched.

Preferably, the display method further comprises the step of displaying a search screen for the audio data on the display when the audio image is selected, and the search screen may be arranged in response to the selection of attribute data contained in the audio image.

Accordingly, in embodiments of the present invention, since the audio image displayed on the navigation image automatically disappears after a predetermined time elapses, the audio image does not become a hindrance to the navigation image. Thus, the user is able to utilize the navigation image as usual. Additionally, the user is able to confirm information about the content of audio data being reproduced or to be reproduced through the audio image. When the audio image is selected, the screen may be switched to a content search screen, thereby allowing a content search to be performed using fewer operations and frequency compared to the conventional technique.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a chart illustrating the construction of an on-vehicle electronic system according to a first embodiment of the present invention;

FIG. 2 is a block diagram illustrating the construction of an AVN system shown in FIG. 1;

FIG. 3 is a functional block diagram of a pop-up display program according to the first embodiment;

FIG. 4 is a chart explaining the timing for starting display of a pop-up image according to the first embodiment;

FIG. 5 is a chart illustrating an example of a configuration of music data;

FIG. 6(a) is an illustration of a data format for a general pop-up image, and FIG. 6(b) is the data format of a split pop-up image;

FIG. 7 is an illustration of a table organizing the navigation images by display priority.

FIG. 8 is a chart illustrating the display position of a pop-up image, in which FIG. 8(a) illustrates a case where a vehicle drives straight through first and second intersections, FIG. 8(b) illustrates a case where a vehicle drives straight through the first intersection and turns right at the second intersection, and FIG. 8(c) illustrates a case where a vehicle drives straight through the first intersection and turns left at the second intersection;

FIG. 9 is a flow chart of the operations for displaying a pop-up image according to the first embodiment;

FIG. 10(a) illustrates a display state in which a pop-up image is displayed, and FIG. 10(b) illustrates a display state in which the pop-up image disappears;

FIG. 11 is a functional block diagram of a pop-up display program according to a second embodiment of the present invention;

FIG. 12 is a flow chart of the operations for displaying a pop-up image for searching music, according to the second embodiment;

FIG. 13(a) illustrates a music search screen, FIG. 13(b) illustrates a genre search screen, and FIG. 13(c) illustrates a music list;

FIG. 14 is a flow chart of operations for displaying a pop-up image for searching music, according to a third embodiment;

FIG. 15 is an example of displaying a pop-up image according to the third embodiment; and

FIG. 16(a) illustrates an example of displaying a pop-up image for TV, and FIG. 16(b) illustrates an example of an EPG search screen.

### DESCRIPTION OF THE PREFERRED EMBODIMENTS

Embodiments of an on-vehicle AVN system of the present invention will be described in detail below with reference to the accompanying drawings.

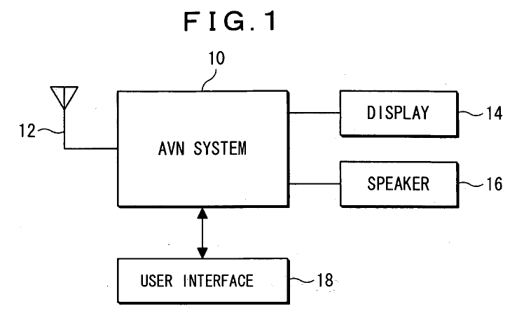

FIG. 1 is a block diagram illustrating an on-vehicle electronic system according to a first embodiment. An AVN system 10 includes an antenna 12 for receiving television and radio broadcasts and the like, a display 14 that is shared in the system, a speaker 16, and a user interface 18 for interfacing with a user. The AVN system 10 includes a navigation function, an audio function, and a video function that are integrated together.

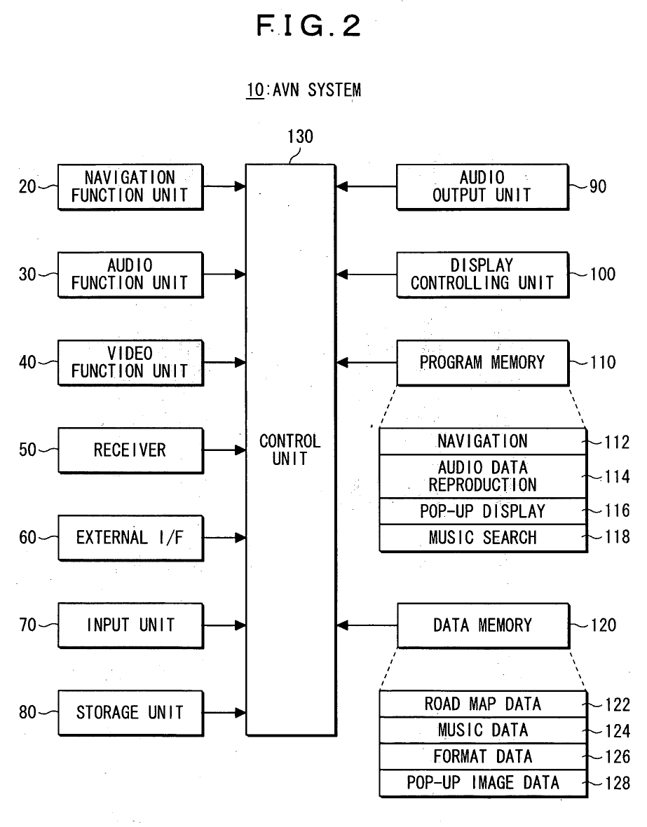

FIG. 2 is a block diagram illustrating a detailed constriction of the AVN system shown in FIG. 1. The AVN system 10 is comprised of a navigation function unit 20 configured to guide a route to a destination, an audio function unit 30 configured to reproduce audio data, a video function unit 40 configured to present video data on a display, a receiver 50 configured to receive television broadcast signals and radio broadcast signals from the antenna 12, an external interface (external I/F) 60 configured to interface with external portable media and the like, an input unit 70 configured to input a user's instruction through a touch panel or a keyboard, a storage unit 80 configured to store various data and programs for executing each of the functions of the various components, an audio output unit 90 configured to supply audio signals to the speaker, a display controlling unit 100 configured to supply image data to the display, a program memory 110, a data memory 120, and a control unit 130 configured to control each of the units.

The navigation function unit 20 calculates a vehicle position using a GPS satellite and a dead reckoning sensor, reads out road map data surrounding the vehicle position from the storage unit 80, and presents the read-out data along with a vehicle position mark on the display. Further, the navigation function unit 20 searches for a route from the vehicle position to a destination set by the user, and displays an optimum guidance route on the road map image to give the user route guidance to the destination.

The audio function unit 30 reproduces the audio data stored in a CD, DVD, semiconductor memory, portable media device or other storage media, as well as the audio data contained in the radio and television broadcasts.

The video function unit 40 reproduces the video data stored in a DVD, semiconductor memory, portable media device or other storage media, as well as the video data contained in the television broadcast.

The program memory 110 by itself stores programs, or stores the program(s) loaded from the storage unit 80. The programs may include a navigation program 112 for executing the navigation function, an audio data reproduction program 114 for reproducing the audio data, and a video data reproduction program 116 for reproducing the video data. Further, in the first embodiment, the program memory 10 stores a pop-up display program 116 for displaying a pop-up image containing audio information related to the audio data when the navigation function is being executed as described later, and/or a music search program 118 for searching music through the pop-up image, etc.

The data memory 120 stores data for executing the programs. For example, the data memory 120 may store road map data 122 surrounding the vehicle position at the time the navigation function is executed, audio data reproduced at the time the audio function is executed, format data 126 for displaying the above described audio information as pop-up images, and pop-up image data 128 for the pop-up images.

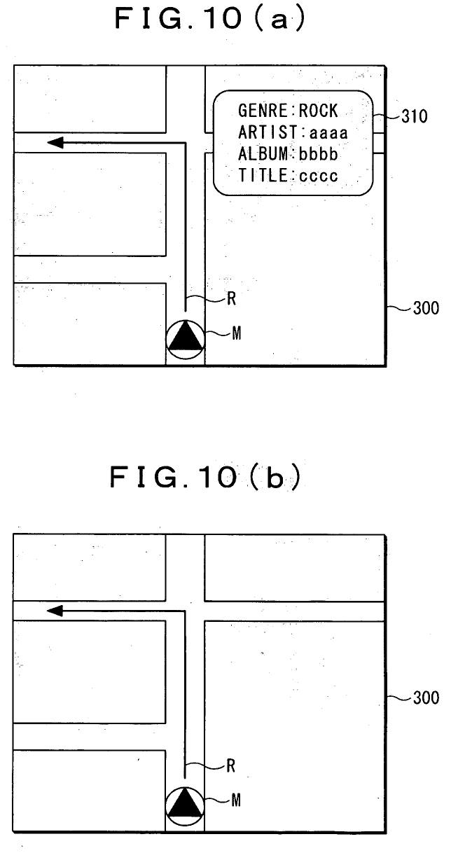

When the navigation function is executed, the AVN system in the first embodiment displays the navigation image on the display. When the audio function is executed during the execution of the navigation function, the AVN system can display a pop-up image of the audio information related to the audio data currently being reproduced. As shown in FIG. 10(a), for example, when the audio data is reproduced while a road map image 300 is presented on the display, the AVN system displays a pop-up image 310 of the audio information related to the audio data currently being reproduced.

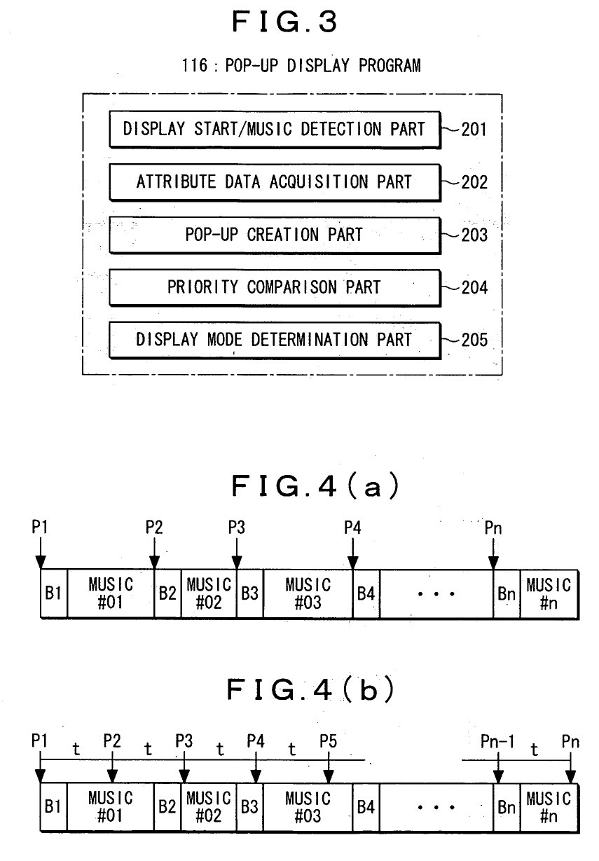

FIG. 3 is a functional block diagram of the pop-up display program 116 according to the first embodiment. The pop-up display program 116 includes a display start/music detection part 201 that determines a timing for displaying a pop-up image and detects target music, an attribute data acquisition part 202 that acquires the attribute data of music currently being reproduced, a pop-up creation part 203 that creates a pop-up image, a priority comparison part 204 that compares the priority of a navigation image to that of a pop-up image, and a display mode determination part 205 that determines the display position and display time of a pop-up image.

Next, the operation of the display start/music detection part 201 will be described. FIG. 4(a) illustrates an example of the display start/music detection part 201 starting to display a pop-up image, when a blank in the audio date is detected. When a reproduction list L is created, music data is arranged in the order it will be reproduced. For example, a blank B, which is a blank part for several seconds, is set before and after each of the music data (e.g. MUSIC #01). The display start/music detection part 201 sequentially detects the blanks for the individual music data, and detects the music data that will be played directly after the blank. For example, when detecting a blank B1 that is set before music #01, the display start/music detection part 201 starts displaying the pop-up image including the attribute data for music #01. Next, when detecting a blank B2 that is set before music #02, the display start/music detection part 201 starts displaying the pop-up image including the attribute data for music #02.

FIG. 4(b) illustrates an example of the display start/music detection part 201 starting to display a pop-up image at specific time intervals. In response to starting points P1, P2, . . . Pn set at specific time intervals “t” that are received from a timer, for example, the display start/music detection part 201 detects the music data corresponding to each starting point P. When a starting point corresponds to a blank, the music data directly after the blank is detected; and when a starting point corresponds to music data currently being reproduced, the music data for the music currently being reproduced is detected. For example, at a first starting point P1 the display start/music detection part 201 detects the music #01 directly after the blank B1, thus, the pop-up image is displayed including the attribute data of the music #01. Next, at a second starting point P2 located after the specific time t has elapsed from the first starting point P1, the music #01 currently being reproduced is detected, and the pop-up image including the attribute data for the music #01 is displayed. The display start/music detection part 201 may use either method of FIG. 4(a) or FIG. 4(b), or may use both methods simultaneously.

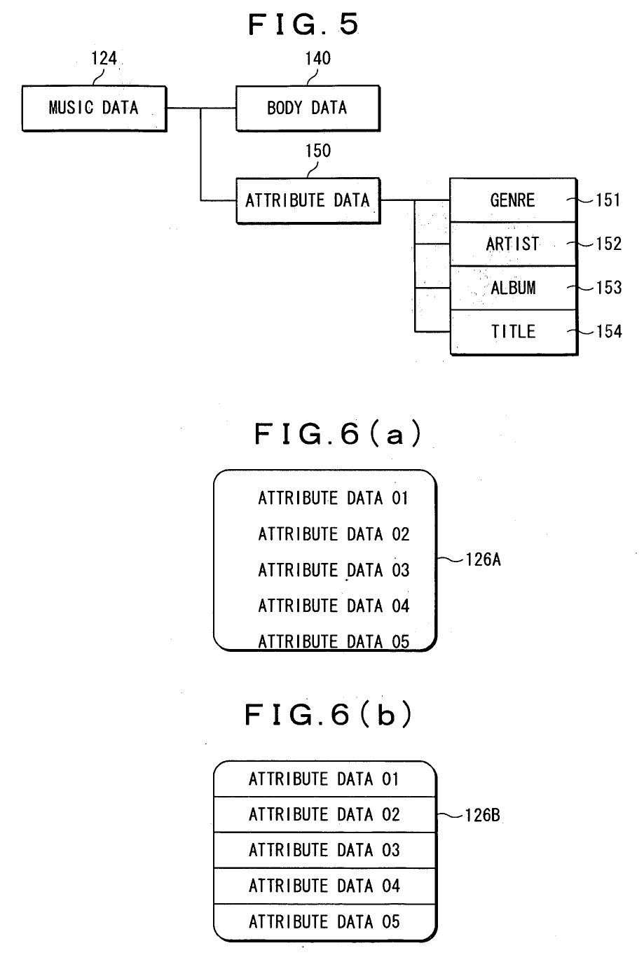

In response to the detection of music by the display start/music detection part 201, the attribute data acquisition part 202 acquires the attribute data for the corresponding music data. FIG. 5 is a chart illustrating an example of the music data configuration. The music data 124 includes body data 140, which is the music itself, and attribute data 150 that characterizes the music data 124. The attribute data 150 includes, for example and without limitation, genre data 151, artist data 152, album data 153, and title data 154, etc. The attribute data acquisition part 202 delivers the attribute data 150 acquired from the music data 124 to the pop-up creation part 203.

The pop-up creation part 203 reads out the format data 126 from the storage unit 80, writes the attribute data 150 delivered from the attribute data acquisition part 202 into a blank part of the format data, and creates the pop-up image data 128. The color tone of the pop-up image is preferably semitransparent so that the background navigation image can be partially seen through the pop-up image. Further, the color of the pop-up image may be varied to synchronize with the color of the navigation image, which varies according to the time zone, time of day (e.g. morning, daytime and night), and/or the geography of the map displayed on the navigation image (e.g. a mountainous region, a coastline and the like). When the color of the navigation image becomes navy blue in the night time, for example, the color of the pop-up image may be changed to a contrasting color such as red or white.

FIG. 6(a) illustrates an example of a format 126A for a pop-up image in which the entire attribute data is written into one pop-up image; and FIG. 6(b) illustrates an example of a format 126B for a split pop-up image in which the area of the pop-up image is delimited by each attribute data. These two formats do not differ in verification of the attribute data; however, as described in the third embodiment, the 126B format facilitates the search procedure for music when the pop-up image is used as a switching function image.

The priority comparison part 204 compares the priority of a pop-up image to various types of navigation images, and determines whether to display the pop-up image. The navigation images provide wide area road map images, narrow area road map images, intersection guidance images, input images and the like, to effectively display a guidance route. If the pop-up image is always displayed, it may mask important information of the navigation images. Accordingly, a priority is set in advance for various types of navigation images; and a high priority is given to the display of intersection guidance images and the like as masking them with a pop-up image may be a hindrance to driving. In contrast, a low priority is given to the display of such navigation images that may not be a hindrance to driving.

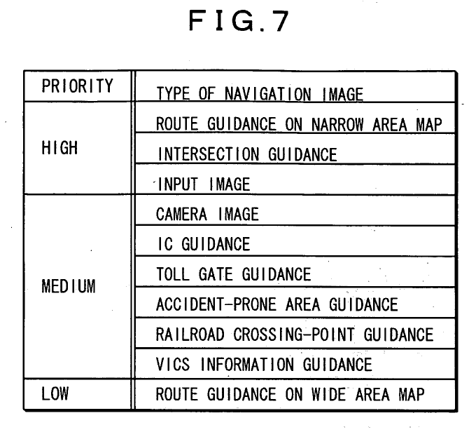

FIG. 7 is a table listing the priorities for displaying various types of navigation images. The priority “high” means that the priority of displaying a navigation image is high as compared to the priority of displaying a pop-up image; the priority “medium” means that the priorities of displaying both the navigation image and the pop-up image are the roughly the same and the user can set or select either; and the priority “low” means that the priority of displaying a navigation image is low as compared to the priority of displaying a pop-up image. For example, a low priority is set to the route guidance image on a wide area map (scale: over 1/25,000), and a high priority is set to the route guidance image on a narrow area map (scale: below 1/50,000, for example), the intersection guidance image, and the input image over the pop-up image. The camera image, IC (interchange) guidance image, toll gate guidance image, accident-prone area guidance image, railroad crossing-point guidance image, and VLCS information guidance image have the same priority as the pop-up image, and these navigation images are set to have a higher priority than the pop-up image in the default. However, the priority can be varied in accordance with the user's selection.

The display mode determination part 205 determines the display position and display time of a pop-up image. The pop-up image is preferably displayed at a position where the vehicle position, the nearest intersection, the intersection for changing the driving direction, the guidance route, and the other icons are not masked as much as possible.

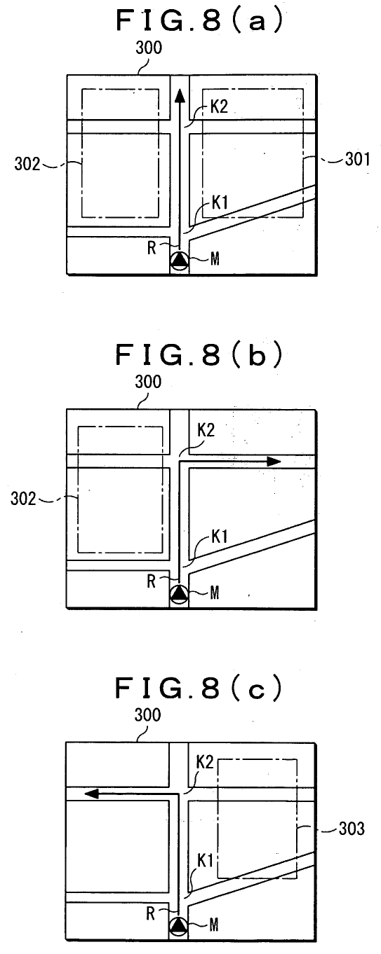

FIG. 8 is a chart illustrating the display position of a pop-up image on a road map image 300. The road map image 300 displays a first intersection K1, a second intersection K2, a vehicle position mark M, and a guidance route R. FIG. 8(a) illustrates a case in which a vehicle drives straight through both the first intersection K1 and the second intersection K2. In this case, display areas 301 and 302 are selected as a candidate display positions which do not overlap with the vehicle position mark M, the guidance route R and the intersections K1 and K2. Of these candidate display areas 301, 302, the candidate display area 301, 302 that does not overlap with the other icon displays is finally selected as the display position. FIG. 8(b) illustrates a case in which a vehicle drives straight through the first intersection K1 and turns right at the second intersection K2. In this case, the display area 302 is selected as the candidate display position, which does not overlap with the vehicle position mark M and the intersections K1 and K2 and which is opposite to the driving direction of the guidance route R. FIG. 8(c) illustrates a case in which a vehicle drives straight through the first intersection K1 and turns left at the second intersection K2. In this case, the display area 303 is selected as a candidate of the display position, which does not overlap with the vehicle position mark M and the intersections K1 and K2 and which is opposite to the driving direction of the guidance route R.

The display mode determination part 205 sets the display time of a pop-up image to three seconds, for example, as the initial setting. However, the display time may be varied by a user but is preferably restricted to within five seconds at a maximum, for example, to prevent a driver from looking at the pop-up image for too long while driving.

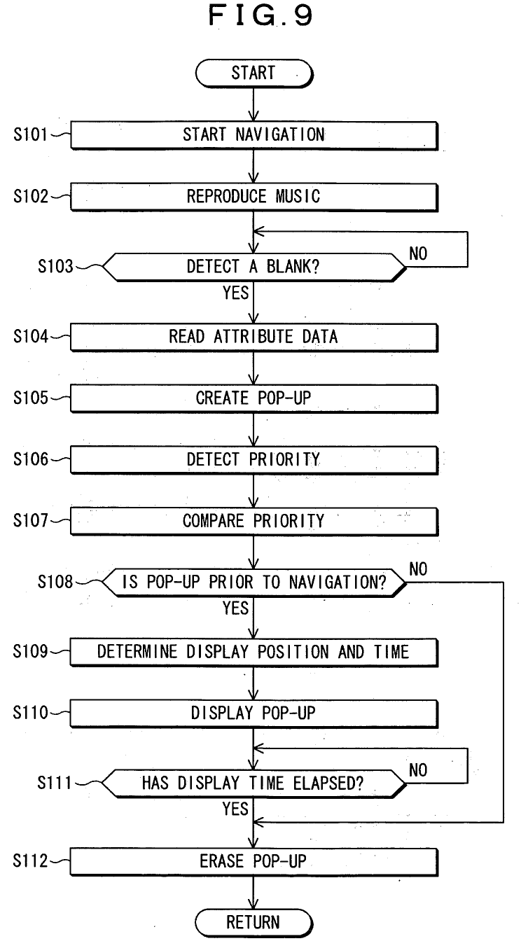

Next, the display operation of a pop-up image in the AVN system of the first embodiment will be described with reference to the flow chart of FIG. 9. First, a navigation function of the navigation function unit 20 is executed (step S101), and the road map surrounding the vehicle position etc. is presented on the display. Next, along with the navigation function, an audio reproduction function of the audio function unit 30 is executed, and music data is reproduced (step S102). Multiple pieces of music contained in the media such as a playlist, a CD, or the like may be reproduced in a predetermined order or randomly.

In response to the execution of the audio function, the pop-up display program 116 is started. When the display start/music detection part 201 detects blanks of the multiple pieces of music contained in the playlist, the CD, or the like (step S103), the attribute data acquisition part 202 reads out the attribute data for the music data following the blanks (step S104). The read-out attribute data is provided to the pop-up creation part 203, and the pop-up creation part 203 writes the attribute data in the blank of the format data and creates the pop-up image data 128 (step Sl05).

Next, the priority comparison part 204 detects the priority of the navigation image currently being displayed (step S106), and compares it with the priority of the pop-up image (step S107). When the priority of the pop-up image is higher than the priority of the navigation image being displayed (step S108), the display mode determination part 205 determines the display position and the display time for the pop-up image (step S109). In response to this determination, the display controlling unit 100 synthesizes the pop-up image on the navigation image and presents the synthesized image on the display (step S110). The display mode determination part 205 measures the display time of the pop-up image and when the display time is determined to have elapsed (step S111), the display controlling unit 100 stops the display of the pop-up image (step S112). When the priority of the navigation image is higher than the pop-up image being displayed, the display of the pop-up image is skipped. That is, the pop-up image is not displayed.

FIG. 10(a) illustrates a state in which a pop-up image is displayed on a navigation image and FIG. 10(b) illustrates a state in which the pop-up image is not displayed on the navigation image.

When an audio reproduction function is executed while a navigation function is being executed, the pop-up image 310 is synthesized and displayed on the road map image 300, as shown in FIG. 10(a). The pop-up image 310 is semitransparent, and is displayed in a position that does not hinder the road map from being viewed as much as possible. This pop-up image 310 represents the genre, artist, album, and title.

After being displayed for a given period of time, the pop-up image 310 disappears, as shown in FIG. 10(b). After a given time elapses, or when the music data currently being reproduced is switched to the next music data, the next pop-up image is displayed.

Next, a second embodiment of the present invention will be described. In the second embodiment, a pop-up image functions as a user interface. In this embodiment, when a user selects a displayed pop-up image, an audio reproduction function is automatically switched to a music search function.

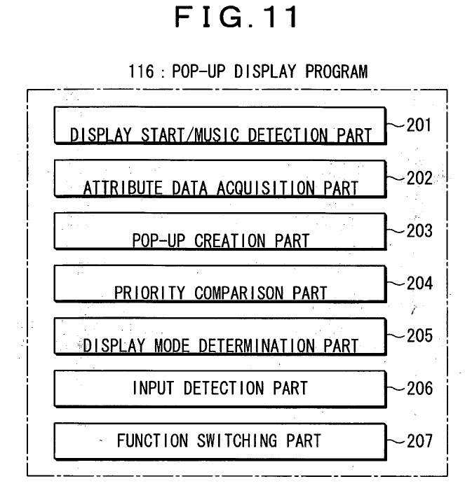

FIG. 11 is a functional block diagram of a pop-up display program according to the second embodiment. The second embodiment includes an input detection part 206 and a function switching part 207, in addition to the functional block diagram of the first embodiment. The input detection part 206 detects whether a pop-up image currently being displayed has been pressed or selected by a panel touch or a key input or the like. The function switching part 207 switches the screen on the display from a navigation screen to a music search screen when the input detection part 206 detects that the pop-up image is selected.

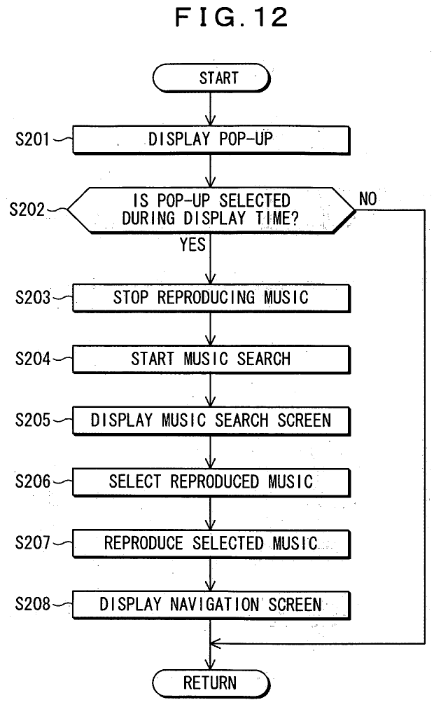

FIG. 12 is a flow chart illustrating operations for displaying a pop-up image for searching music, according to the second embodiment. Because the method of displaying a pop-up image is the same as the first embodiment shown in FIG. 9, the description thereof will be omitted.

First, a pop-up image is displayed on a navigation image (step S201). The pop-up image is assumed to have a format as shown in FIG. 6(a), for example. The input detection part 206 detects whether the pop-up image is selected during the display of the pop-up image (step S202). When the pop-up image is selected, the audio data reproduction program 114 stops reproducing the music (step S203), and starts the music search program 118 (step S204).

When the music search program 118 is started, the function switching part 207 instructs the display controlling unit 100 to switch the display screen, whereby the display is switched from the navigation screen to the music search screen (step S205).

The music search screen may be a screen on which music is arranged hierarchically according to a plurality of attributes or a search screen associated with the attribute data of the pop-up image. If the genre of the music currently being reproduced is rock, for example, a search screen may be displayed which lists the music having the attribute of rock, or a search screen may be displayed which lists the music by the artist of the music data currently being reproduced. Alternatively, a search screen of may be displayed that lists the album or playlist of the music data currently being reproduced. Thus, in the second embodiment the search operation is simplified.

When music to be reproduced is selected (step S206), the music search program 118 ends, and the audio data reproduction program 114 starts reproducing the selected music (step S207). Once the music reproduction begins, the function switching part 207 instructs the display controlling unit 100 to switch the display screen from the music search screen to the navigation screen (step S208). Once the screen is switched to the navigation screen, the pop-up image is displayed discontinuously on the navigation image in the same manner as the first embodiment.

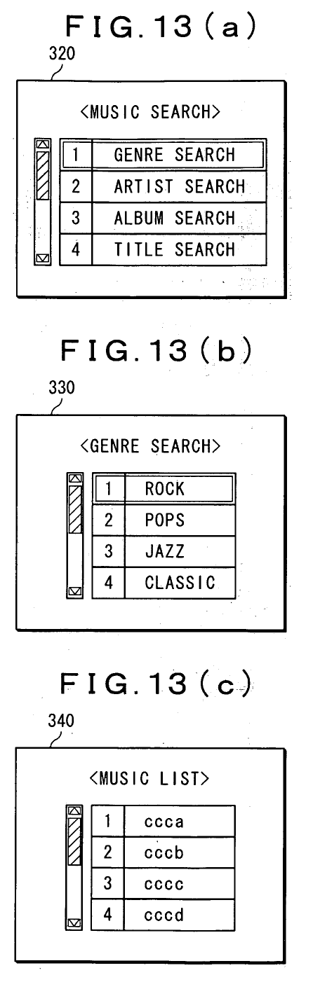

FIG. 13(a) illustrates an example of displaying a music search screen 320. In the search screen 320 various types of searches can be selected, such as a genre search, an artist search, an album search or a title search for desired music.

If the genre search is selected on the music search screen 320 shown in FIG. 13(a), for example, a genre search screen 330 is displayed as shown in FIG. 13(b), in which the music genres such as rock, pops, jazz, and classic are listed. Next, if the genre “rock” is selected in the genre search screen 330, a music list 340 is displayed which gives the titles of music belonging to the “rock” genre, as shown in FIG. 13(c), and the music to be reproduced is determined. When there are many pieces of music listed on the music list, for example, over 100 pieces of music, a condition to narrow the list may be added, such as artist name, album name, Japanese music, foreign music and the like.

Next, a third embodiment of the present invention will be described. Recently, the “failure to look ahead properly during the operation of audio function” has been viewed as the cause of many accidents, thus a music search method requiring less frequent operations is necessary. Accordingly, the third embodiment discloses a music search method requiring less operational frequency as compared to the second embodiment.

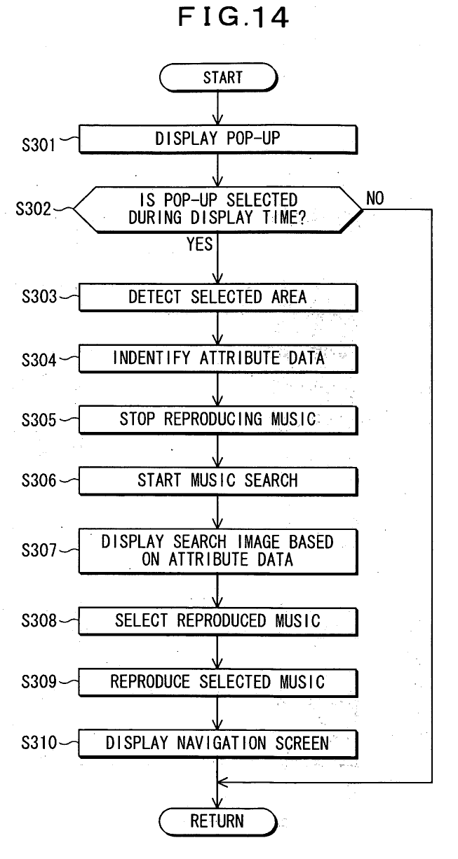

FIG. 14 is a flow chart of the operations for displaying a pop-up image for searching music according to the third embodiment. Initially, a pop-up image is displayed to be synthesized on a navigation image in the same manner as the first embodiment, (step S301). Here, the pop-up image is assumed to have the format 126B shown in FIG. 6(b). When using the format 126B, the pop-up image is capable of providing an input interface that is split according to each attribute data. FIG. 15 illustrates an example of displaying a split pop-up image 350 listing the input interface by each attribute data. The split pop-up image 350 may include a genre area 352, an artist area 354, an album area 356, and a title area 358.

The input detection part 206 detects whether the split pop-up image 350 currently being displayed is pressed or selected (step S302). If the split pop-up image is selected, the input detection part 206 detects which area of the split pop-up image is pressed or selected (step S303) and identifies the attribute data corresponding to a pressed area (step S304). If the genre area 352 is selected, for example, the input detection part 206 identifies the genre as the attribute data. Next, the reproduction of the music is stopped (step S305), and the music search operation is started (step S306). The music search program 118 displays the search screen based on the attribute data of the selected area. If the genre area is selected, for example, the music search program 118 displays the genre search screen 330 as shown in FIG. 13(b). Thereafter, the operation is the same as the second embodiment.

Next, a fourth embodiment of the present invention will be described. In the fourth embodiment, the music data reproduced by the audio function unit 30 includes not only the data stored in the storage unit 80 or the portable media device, but also the data from a terrestrial digital television broadcast and a radio broadcast received by the receiver 50. The terrestrial digital television broadcast includes an electronic program guide (hereinafter referred to as EPG), in addition to image and audio data having higher picture quality and higher sound quality than conventional broadcast signals. While driving a vehicle, generally it is not allowed to display a television image on the display, however, outputting sounds from the television broadcast is allowed. In the fourth embodiment, a pop-up image related to the program contents of the received radio or television broadcast is displayed on a navigation screen.

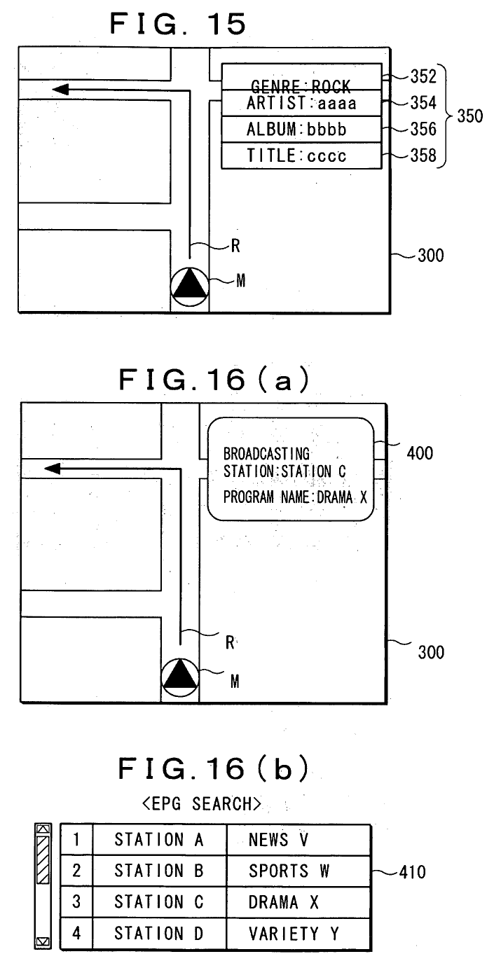

In the fourth embodiment, the display start/music detection part 201 displays the pop-up image related to the received program contents at the start of the broadcasting of a program or at specific time intervals. The attribute data acquisition part 202 acquires the names of broadcasting stations and programs, etc. from the EPG as the attribute data, and the pop-up creation part 203 creates a TV pop-up image in which the attribute data is listed. When the display mode determination part 205 determines the display position and display time for the TV pop-up image, the display controlling unit 100 displays the TV pop-up image on the navigation image. FIG. 16(a) illustrates an example of a TV pop-up image 400 displayed on the navigation image 300. The TV pop-up image 400 shows “C station” as the broadcasting station currently being received, and “drama X” as the program name currently being broadcast. Additionally, the broadcasting time zone and the performer's name and the like may be showed. After being displayed on the navigation image for a predetermined time, the TV pop-up image automatically disappears.

Further, in the same manner as the second and third embodiments, when the TV pop-up image 400 is pressed or selected, the image may be switched to an EPG search screen 410, as shown in FIG. 16(b). The EPG search screen 410 displays a list of receivable stations broadcasting TV programs, program names and the like. When a desired program is selected, the broadcasting station is switched to the station broadcasting the selected program.

Note that the size, shape, color and the like of the pop-up images displayed on the navigation image in any of the above described embodiments may be varied appropriately to conform to the display and the background navigation image. Further, the attribute data displayed on the pop-up image is not limited to those of the above embodiments, and attribute data may be added or varied appropriately. Furthermore, the pop-up image may add information such as a performance time of music being reproduced (i.e. the length of a music track), a remaining performance time, and the music to be reproduced next.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An on-vehicle electronic system comprising:
a navigation unit configured to perform a road guidance function;
an audio reproduction unit configured to reproduce audio data;
a display; and
a display control unit configured to display a navigation image for a guidance function on the display when the road guidance function is executed, and display an audio image related to the audio data currently being reproduced or to be reproduced by the audio reproduction unit on the navigation image for a predetermined period of time when an audio reproduction function is executed while the road guidance function is being executed.

2. The on-vehicle electronic system according to claim 1, wherein the display control unit displays the audio image at predetermined time intervals.

3. The on-vehicle electronic system according to claim 1, wherein the display control unit displays the audio image in response to blank sections in the audio data.

4. The on-vehicle electronic system according to claim 1, wherein the display control unit displays the audio image in a semitransparent state.

5. The on-vehicle electronic system according to claim 1, wherein the display control unit includes an attribute data acquisition unit that acquires attribute data from the audio data currently being reproduced or to be reproduced by the audio reproduction unit, and a creation unit that creates the audio image based on the acquired attribute data.

6. The on-vehicle electronic system according to claim 1, wherein the display control unit includes a display position determination unit that determines a position on the display that does not overlap with intersections or a guidance route on the navigation image, and wherein the audio image is displayed at the position determined by the display position determination unit.

7. The on-vehicle electronic system according to claim 1, wherein the display control unit includes a priority comparison unit that compares a predetermined priority for displaying the audio image to a predetermined priority for displaying the navigation image, and when the priority for displaying the audio image is determined to be higher than the priority for displaying the navigation image by the priority comparison unit, the display control unit displays the audio image.

8. The on-vehicle electronic system according to claim 7, wherein, when the priority for displaying the audio image is determined to be lower than the priority for displaying an intersection guidance image by the priority comparison unit, the display control unit does not display the audio image.

9. The on-vehicle electronic system according to claim 7, wherein, when the priority for displaying the audio image is determined to be lower than the priority for displaying an input screen of a navigation function, the display control unit does not display the audio image.

10. The on-vehicle electronic system according to claim 1, wherein the display control unit further includes a detection unit for detecting whether the audio image currently being displayed has been selected, and wherein the display control unit displays a search screen for the audio data on the display in response to the detection by the detection unit.

11. The on-vehicle electronic system according to claim 10, wherein the audio image includes at least a first display area for displaying first attribute data and a second display area for displaying second attribute data, and wherein the detection unit detects whether either of the first and the second display areas is selected, and the display control unit displays a search screen associated with the selected first or the second attribute data in response to the selection of the first or the second display area.

12. The on-vehicle electronic system according to claim 1, wherein the display control unit changes a display color of the audio image in accordance with a background color of the navigation image.

13. The on-vehicle electronic system according to claim 1, further comprising a receiving unit that receives at least one of television and radio broadcasts, wherein the audio unit reproduces the audio data of the received television or radio broadcast, and the display control unit displays the audio image related to the audio data associated with the television or radio broadcast currently being received or to be received by the receiving unit on the navigation image for a given period.

14. The on-vehicle electronic system according to claim 13, wherein the display control unit includes an attribute data acquisition unit that acquires attribute data from an electronic program guide received by the receiving unit, and a creation unit that creates the audio image based on the attribute data.

15. A method of displaying an audio image related to audio data on a navigation image in an on-vehicle electronic system, comprising the steps of:
displaying a navigation image on a display;
reproducing audio data; and
displaying an audio image related to the audio data currently being reproduced or to be reproduced by an audio reproduction unit for a predetermined period of time on the navigation image.

16. The method according to claim 15, wherein the audio image is repeatedly displayed at predetermined time intervals.

17. The method according to claim 15, wherein the audio image is displayed each time the audio data being reproduced is changed.

18. The method according to claim 15, further comprising the step of displaying a search screen for the audio data on the display, when the audio image is selected.

19. The method according to claim 18, wherein the search screen is selected in response to the selection of attribute data contained in the audio image.

20. The method according to claim 18, wherein the audio image is displayed at a position that does not overlap with a guidance route and intersections on the navigation image.
